(19) United States
(12) Patent Application Publication
(10) Pub. No.: US 2007/0267588 A1
(43) Pub. Date: Nov. 22, 2007

(54) Seal for water valve

(75) Inventors: R. Allan McLane, Powell, OH (US); Robert Norris, Hilliard, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/436,361

(22) Filed: May 18, 2006

(51) Int. Cl. F16K 25/00

(52) U.S. Cl. 251/175

(57) ABSTRACT

A seal for sealing a flow control valve is provided. The seal includes an inlet configured to mate with a flow control device, an outlet configured to mate with a housing, and a convolution formed in a seal wall and interposed between the inlet and outlet. The convolution expands the seal wall when a differential pressure across the convolution is increased.

### FIELD OF THE INVENTION

This invention generally relates to flow control valves and, in particular, to a seal for use in a flow control valve.

### BACKGROUND OF THE INVENTION

A valve such as, for example, a barrel valve is a flow control device used to manage a flow of fluid through a section of pipe. The typical barrel valve includes, among other things, a hollow barrel-shaped housing and a rotatable shaft having a channel passing therethrough. An upper portion of the rotatable shaft is coupled to an actuator.

To open the valve, the actuator moves the rotatable shaft until the channel is aligned with an inlet and an outlet in the housing. In this orientation, the valve permits the fluid to flow freely through the valve. To close the valve, the actuator moves the rotatable shaft until the channel is impeded by the housing and misaligned with respect to the inlet and outlet in the housing. In this orientation, the valve restricts the fluid from flowing through the valve. To meter fluid flow through the valve, the actuator moves the rotatable shaft until the channel is partially aligned with the inlet and outlet in the housing. With the valve generally positioned somewhere between the fully open and closed positions, the valve partially permits or meters the fluid flowing through the valve.

To ensure that leakage of the fluid is reduced or, preferably, eliminated when the barrel valve is at or in between the open and closed positions, the barrel valve generally includes one or more seals. In a conventional barrel valve, at least one of these seals is interposed between mating members of the housing, between the housing and the rotatable shaft, and the like to ensure that the fluid does not undesirably escape from the valve.

To promote a good seal, the seal must maintain contact with adjacent structures which, in this case, are the housing and the rotatable shaft. The contact requirement is often accomplished using a variety of different biasing devices and methods. For example, supplemental springs are often coupled to or incorporated in the seal to provide a tensile force. The tensile force expands or elongates the seal such that opposing ends of the seal are biased against the housing and rotatable shaft. Alternatively, clamps are wrapped around the seal and used to provide a compressive force. Like the tensile force, the compressive force also expands or elongates the seal such that opposing ends are pushed against the housing and the rotatable shaft. By forcibly biasing the ends toward mating structures, the sealing relationship is formed, the integrity of the seal is maintained, and leakage is prevented.

Unfortunately, the use of springs and clamps to maintain a seal between adjacent structures has significant drawbacks. For example, typical springs and clamps are constructed of metal. Because metal is relatively expensive compared to polymers and other typical valve construction materials, the springs and clamps add considerably to the overall cost of the valve. The metal is also subject to corrosion and, consequently, failure. This leads to the need for frequent inspections and, potentially, the costly and time-consuming replacement of the metal parts.

In addition to being costly and subject to premature failure, the springs and clamps all too often require that additional steps be undertaken during assembly of the valve. For example, the spring has to be attached to the seal and the clamp must be wrapped around the seal. These manufacturing steps add to the overall cost of the valve. Moreover, the assembly equipment required to construct the valve that includes springs and clamps must be more advanced or sophisticated to handle the extra component. In addition, during operation in some cases the springs and clamps undesirably elevate operating torque. Therefore, a larger and more costly actuator must be used to move the rotatable shaft and operate the valve.

In other flow control valves, o-rings are situated between the adjacent structures. The o-rings rely on an interference fit between the housing and rotatable shaft to prevent leakage. By forcing the o-rings into the space between adjacent structures, the o-rings are generally held in compression. The compressive force causes the o-ring to push outwardly toward the adjacent structure and, as a result, the o-ring promotes a tight seal.

Like the springs and clamps, the o-rings also have significant drawbacks. For example, the o-rings rely upon the interference fit to prevent leakage. The interference fit places high compressive loads on the seal. These high compressive loads make the seal more prone to failure. Moreover, if tolerances of the o-ring or adjacent structure are off, the seal may undesirably permit leakage.

There exists, therefore, a need in the art for a seal for a flow control valve that provides leak-proof sealing, exhibits low operating torque (i.e., low friction), and contributes to a lower overall cost for the valve. The invention provides such a seal. These and other advantages of the invention, as well as additional inventive features, will be apparent from the description of the invention provided herein.

### BRIEF SUMMARY OF THE INVENTION

An embodiment of the present invention provides an elastomeric seal for a flow control valve (e.g., a barrel valve) that provides leak proof sealing, low operating torque (i.e., low friction), and lower cost. The design of the seal preferably includes a convolution proximate the exit section or downstream portion of the seal. As a pressure differential across the convolution increases when, for example, the valve begins to close, the convolution provides a spring force that extends the two opposing ends of the seal. As such, the two ends forcibly expand between mating parts and augment the seal formed therebetween. Contact between each of the two ends and their mating parts is also maintained when the differential pressure is low when, for example, the valve is open. The incorporation of the convolution(s) in the seal eliminates the need for springs or clamps to bias the seal against the flow control valve. Also, the need for an o-ring, which relies upon a friction fit to provide a seal, is eliminated.

In one aspect, an embodiment of the present invention provides a seal for sealing a flow control valve. The seal includes an inlet configured to mate with a flow control device, an outlet configured to mate with a housing, and a convolution formed in a seal wall and interposed between the inlet and outlet. The convolution expands the seal wall when a differential pressure across the convolution is increased.

In another aspect, an embodiment of the present invention provides a flow control valve for selectively routing a fluid. The flow control valve includes a housing, a flow control device, and a seal interposed between the housing and the flow control device. The housing defines an internal cavity and includes an inlet and an outlet in fluid communication with the internal cavity. The flow control device is rotatably positioned within the internal cavity and defines a generally radial channel configured to provide selective fluid communication between the inlet and the outlet. The seal has upstream and downstream surfaces spaced apart by a channel and a convolution formed in a seal wall. The convolution increasingly biases the upstream surface toward the flow control device and the downstream surface toward the outlet when a differential pressure across the seal wall is increased.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front elevation view of an exemplary embodiment of a flow control valve constructed in accordance with the teachings of the present invention;

FIG. 2 is a vertical cross section of the flow control valve of FIG. 1 taken generally along line 2-2;

FIG. 3 is a horizontal cross section of the flow control valve of FIG. 1 taken generally along line 3-3;

FIG. 4 is a perspective view of a seal employed within the flow control valve of FIG. 1;

FIG. 5 is a top plan view of the seal of FIG. 4; and

FIG. 6 is a cross section view of the seal of FIG. 5 taken generally along line 6-6.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

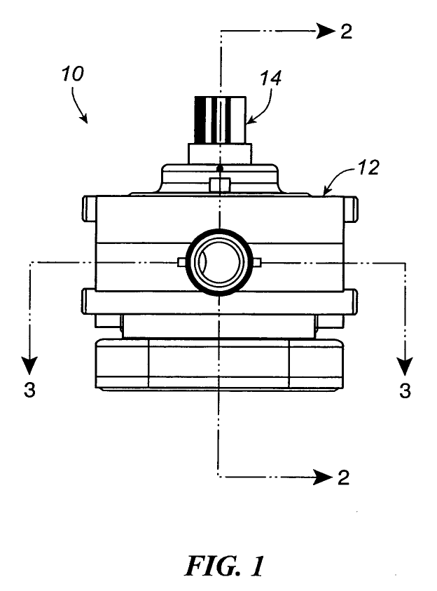

Referring to FIG. 1, a flow control valve 10 for selectively routing a fluid in accordance with the teachings of the invention is illustrated. The flow control valve 10 is able to meter a variety of different fluids such as, for example, water, hydraulic fluid, fuel, a gas, and the like. As shown in FIG. 1, the flow control valve 10 includes a housing 12 and a flow control device 14.

The housing 12 is made of steel, plastic, or another suitable valve material depending on the application and environment for which the flow control valve 10 is used. In the illustrated embodiment, the housing 12 is generally cylindrical or barrel-shaped. Therefore, the flow control valve 10 is referred to as a barrel valve. Even so, in one embodiment the flow control valve 10 is a ball valve, a butterfly valve, or other well known style of valve. In such cases, the housing 12 has one of a variety of different shapes and configurations corresponding to the particular type of valve employed.

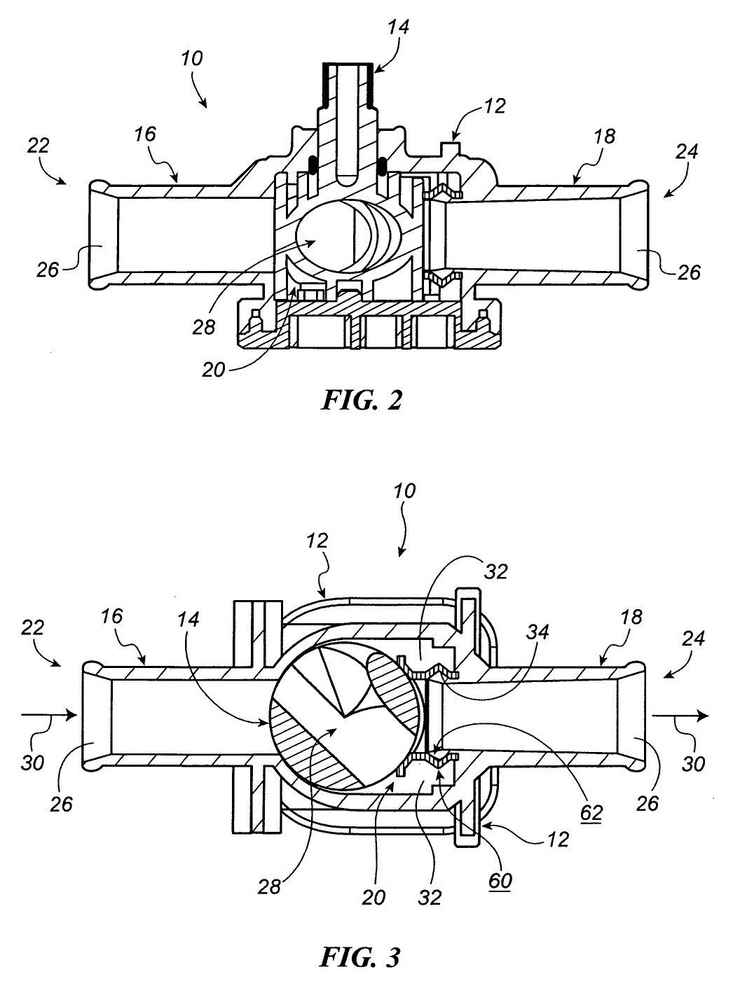

As shown in FIG. 2, the housing 12 defines a valve inlet 16, a valve outlet 18, and an internal cavity 20. The valve inlet 16 and the valve outlet 18 are generally spaced apart from each other and on opposing upstream and downstream ends 22, 24 of the housing 12. In one embodiment, the valve inlet and valve outlet 16, 18 are integrally formed with the remainder of the housing 12. As shown, the valve inlet and valve outlet 16, 18 include coupling structures or devices 26 proximate the upstream and downstream ends 22, 24. The coupling devices 26 (e.g., threads, outwardly flared portions, etc.) permit the flow control valve 10 to be quickly and easily incorporated into a section of pipe, conduit, or other type of fluid carrying structure (not shown).

Referring now to FIG. 3, the internal cavity 20 is situated between, and in fluid communication with, each of the valve inlet and valve outlet 16, 18. The internal cavity 20 is generally configured to house the flow control device 14 in a manner that permits the actuator to rotate the flow control device. The flow control device 14 is able to rotate within the internal cavity 20 in both the clockwise and counterclockwise directions in a preferred embodiment of the present invention.

In the illustrated embodiment, the flow control device 14 is represented as a cylinder having a radial channel 28 passing therethrough. Even so, the flow control device 14 is able to take other shapes or have other configurations depending on the type of the flow control valve 10 used as noted above. As shown, the flow control device 14 is rotatable about an axis generally perpendicular to a direction 30 of fluid flow. In contrast, the radial channel 28 is generally parallel to the direction 30 of fluid flow when the flow control valve 10 permits the full flow of fluid.

In the illustrated embodiment, the flow control device 14 is situated closer to the upstream end 22 of the housing 12. Therefore, a downstream portion 32 of the internal cavity 20 is left generally unoccupied by structural components. As will be discussed more fully below, when the flow control device 14 is rotated into the position shown in FIG. 3, the radial channel 28 feeds a portion of the fluid flow into the downstream portion 32 of the internal cavity 20. When the flow control device 14 is rotated into a position where the radial channel 28 is parallel to the direction 30 of fluid flow, the fluid is expelled only into the valve outlet 18 and then released or jettisoned from the flow control valve 10.

Still referring to FIG. 3, the flow control valve 10 further comprises a seal 34. The seal 34 is generally interposed between the flow control device 14 and the valve outlet 18. As such, the seal 34 prevents and restricts the fluid from undesirably leaking into the valve outlet 18 as the flow control device 14 meters or altogether restricts the fluid from flowing through the flow control valve 10. In one embodiment, the seal 34 is formed from an elastomeric material, a natural rubber, or another like substance.

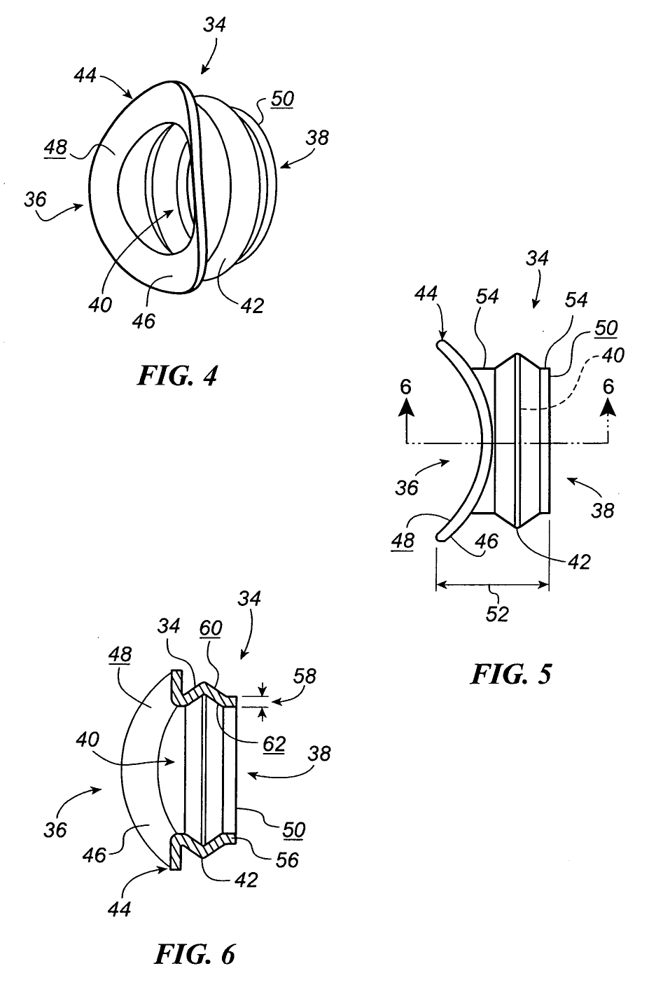

For the purpose of illustration, the seal 34 employed in the illustrated embodiment of FIG. 3 has been extracted from the flow control valve 10 and depicted in FIG. 4 to which attention is now directed. The seal 34 includes an inlet 36, an outlet 38, a channel 40, and a convolution 42. The channel 40 shown in FIG. 4 generally extends between the inlet 36 and the outlet 38 and provides for fluid communication through the seal 34. The channel 40 progresses generally axially through the seal 34. Each of the inlet 36, the outlet 38, and the convolution 42 are integrally formed with each other within an overall seal body 44 in one embodiment of the present invention.

The inlet 36 is configured to sealingly mate with the flow control device 14. In that regard, the inlet 36 in the illustrated embodiment includes a radially outwardly projecting inlet flange 46 that defines an inlet surface 48. To further encourage direct contact between the fluid directing device 14 (best seen in FIG. 3) and the inlet 36 and to promote a sealing arrangement therebetween, the inlet generally has a contoured shape to match the contour of the fluid directing device 14. In the illustrated embodiment, the inlet 36 is saddle-shaped or parabolic to mate with the cylindrical fluid directing device. As those skilled in the art will recognize from the foregoing description, other shapes corresponding to differently configured fluid directing devices 14, e.g., hemispherical to mate with a ball-shaped valving member, are within the scope of the invention.

As illustrated in FIG. 4, the inlet surface 48 has an extensive and ample surface area. As a result, any wear upon the inlet surface 48 is broadly distributed. Even after many cycles of the control valve 10, excessive wear at any particular location is inhibited and/or prevented. By discouraging localized wear on the inlet surface 48, leakage is avoided. In conventional valves that employ an o-ring, the sealing surface is limited and, as a result, wear may leave a flat or worn spot. This worn spot loses contract with the mating part and undesirably permits leakage.

The outlet 38 is configured to sealingly mate with a portion of the housing 12 (e.g., the valve outlet 18). In the illustrated embodiment, and as best shown in FIG. 5, the outlet 38 includes a generally flat and planar outlet surface 50 that mates with the portion of the housing 12 proximate the valve outlet 18. The outlet 38 and outlet surface 50 are able to assume a variety of different configurations in order to mate with the housing 12 and promote a seal therebetween.

Still referring to FIG. 5, the convolution 42 is interposed between the inlet 36 and the outlet 38 within the seal body 44. The convolution 42 is generally a folded or pleated portion of the seal 34 that projects radially outwardly from the channel 40. Although a single convolution 42 is shown, in one embodiment a plurality of convolutions 42 are incorporated into the seal 34. As clearly illustrated in FIG. 5, the convolution 42 allows a portion of the seal 34 to resemble an accordion or bellows.

The convolution 42 generally gives the seal 34 the ability to both expand and contract. Whether the seal 34 expands or contracts depends, in part, upon the angle formed between the portions of the seal wall 56 that form the convolution. If the included angle is greater than ninety degrees, the length 52 of the seal 34 will increase if the pressure on the external surface 62 exceeds that upon the internal surface 60. The portions of the seal wall 56 forming the convolution 42 will be biased away from each other. In contrast, if the included angle is less than ninety degrees, the length 52 of the seal 34 will decrease if the pressure on the external surface 62 exceeds that upon the internal surface 60. The portions of the seal wall 56 forming the convolution 42 will be biased toward each other and, in some cases, may engage each other.

In the illustrated embodiment, when the inlet 36 and outlet 38 are drawn closer together and the seal 34 is compressed along its length 52, the convolution 42 simply projects further radially outwardly to accommodate the linear movement. In contrast, when the inlet 36 and outlet 38 move away from each other and the seal 34 is expanded along its length 52, the convolution 42 falls radially inwardly to accommodate the linear movement. If the seal 34 is expanded enough, the convolution 42 lies flat and/or generally parallel relative to adjacent portions 54 of the seal body 44. As those skilled in the art will recognize, the convolution 42 expands and contracts to permit the seal 34 to correspondingly expand and contract.

As shown in FIG. 6, the seal 34 defines a seal wall 56. The seal wall 56 has a thickness 58, defined by the distance between an external surface 60 and an internal surface 62, that varies with the application of the flow control valve 10. In the illustrated embodiment, the thickness 58 is generally uniform along the entire seal wall 56, which includes the convolution 42. In one embodiment, the thickness 58 of the seal wall 56 varies within the seal 34.

In one embodiment, a portion of the seal 34 near the outlet 38 is fitted over a tapered end of the valve outlet 18. As such, the internal surface 62 mates with the tapered end of the valve outlet 18 and maintains an interference fit. This interference fit is able to encourage formation of a seal, even at low pressures. With an increasing differential pressure across the seal 34, the seal contracts radially inwardly against the valve outlet 18. In one embodiment, the seal 34 relies exclusively upon engagement between the internal surface 62 and the end of valve outlet 18 to form a seal and inhibit or prevent leakage. In such an embodiment, outlet surface 50 of the seal 34 need not maintain contact with the valve outlet 18 or the housing 12.

As those skilled in the art will recognize, the thickness 58 of the seal wall 34 affects the flexibility of the convolution 42, the strength of the seal 34, and the like. The thickness 58 of the seal wall 56 also contributes to the rate at which the seal 34 is able to expand and contract. In general, the thicker the seal wall 56, the slower the seal 34 responds to changing conditions such as, for example, a changing pressure differential across the seal wall 56.

In operation, the valve inlet 16 and valve outlet 18 of the flow control valve 10 are coupled to upstream and downstream pipe sections (not shown), respectively. The pipe sections are configured to transport a fluid such as, for example, water. Because the water is inclined to flow along the direction 30 of fluid flow (see FIG. 3), the valve inlet 16 receives the water from the upstream pipe section. After entering through the valve inlet 16, the water proceeds toward the internal cavity 20.

As the flow control device 14 is rotated by the actuator (not shown) such that the radial channel 28 is moved out of axial alignment with the valve outlet 18 (i.e., generally transverse to the direction 30 of fluid flow), some of the water that had been flowing through the flow control valve 10 is trapped within the downstream portion 32 of the internal cavity 20 and the flow of water through the flow control valve 10 is entirely halted. In this orientation, the flow control valve 10 is in a fully closed position.

Because it was forced into an enclosed space, the water seized or ensnared inside the downstream portion 32 is held under pressure. In contrast, the water in the valve outlet 18 is quickly carried away and allowed to escape the valve 10. As a result of the pressure on the external surface 60 being greater than the pressure on the internal surface 62, a pressure differential across the seal wall 56 is relatively large.

The large pressure differential across the seal wall 56 causes the flexible convolution 42 to move radially inwardly into the channel 40 and compels the seal body 44 to expand along its length 52 (FIG. 5). When the seal body 44 expands, the inlet 36 is forcibly biased against the flow control device 14 and the outlet 38 is forcibly biased against the housing 12 and/or valve outlet 18. Therefore, the inlet surface 48 and the outlet surface 50 are tightly pressed against adjacent structures and, in the closed position, a tight seal is encouraged and water is prevented from leaking.

When the flow control device 14 is rotated by the actuator so that the radial channel is partially axially-aligned with the valve inlet 16 and valve outlet 18 as shown in FIG. 3, the flow control valve 10 is in a partially open or metered flow position. In such an orientation, the water is divided within the flow control valve 10 and travels along two divergent paths. A first portion of water flows from the valve inlet 16, through the radial channel 28, through the channel 40 of the seal 34, and into the valve outlet 18. Once inside the valve outlet 18, the first portion of water is expelled from the flow control valve 10 and enters the downstream pipe section.

The second portion of water flows from the valve inlet 16, through the radial channel 28, and enters the downstream portion 32 of the internal cavity 20. Because the downstream portion 32 of the internal cavity 20 offers no outlet and is quickly filled, the pressure within the internal cavity 20 is elevated compared to the pressure within the valve outlet 18 where the water freely escapes from the flow control valve 10. As a result, the pressure on the external surface 60 of the seal wall 56 is higher than the pressure on the internal surface 62 and, once again, a pressure differential is created across the seal wall 56.

In the partially open position, while the pressure differential is not as great as when the flow control valve 10 is in the fully closed position, there still exists a pressure differential across the seal wall 56. The somewhat diminished pressure differential still causes the flexible convolution 42 to move somewhat radially inwardly into the channel 40 and compels the seal body 44 to expand somewhat along its length 52 (FIG. 5). As before, the expanding seal body 44 biases the inlet 36 against the flow control device 14 and biases the outlet 38 against the housing 12 and/or valve outlet 18. Despite the reduced forces, the inlet surface 48 and the outlet surface 50 are nonetheless pressed against adjacent structures. This action promotes a seal between components proximate the seal 34 yet permits the flow control device 14 to be rotated without considerable difficulty and/or hardship. The lack of any leakage or any significant leakage through the seal 34 coupled with the ability of the flow control device 14 to rotate within the flow control valve 10 without distress ensures precise and efficient metering.

When the flow control device 14 is moved from the partially aligned position of FIG. 3 such that less of the water flows to the internal cavity 20 and more of the water flows to the valve outlet 18, the pressure differential across the seal wall 34 decreases. The diminished pressure differential permits the convolution 42 to move radially outwardly away from the channel and the seal body 44 to contract. Even so, the inlet 36 is still biased against the flow control device 14 and the outlet 38 is still biased against the housing 12 and/or valve outlet 18. The biasing force is simply somewhat diminished in comparison to when more of the water was routed to the internal cavity 20. Despite the weaker pressure differential, the inlet surface 48 and the outlet surface 50 are nonetheless pressed against the adjacent structures.

If the flow control device 14 is rotated by the actuator such that the radial channel 28 is fully axially aligned with the valve inlet 16, the flow of water is permitted to freely flow through the flow control valve 10 and all of the water enters the radial channel 28. In such a case, the flow control valve 10 is in a fully opened position and the pressure differential across the seal wall 56 is small or negligible. Despite this slight pressure differential, the inlet surface 48 is still biased against the flow control device 14 and the outlet surface 50 is still biased against the housing 12 and/or valve outlet 18 due to the size, flexibility, elasticity, and/or other characteristics of the seal 34. In addition, because of the generally smooth, laminar flow of the water through the flow control valve 10, the stress on the seal 34 is, in many circumstances, minimal. Also, even if leakage occurs, this is acceptable since any leaking water will simply join the water that has been permitted to flow.

From the foregoing, those skilled in the art will recognize that the invention provides an elastomeric seal for a flow control valve (e.g., a barrel valve) that provides leak proof sealing, low operating torque (i.e., low friction), and lower cost compared to when springs, clamps, and/or o-rings are used. The seal performs these tasks by utilizing one or more convolutions to expand or contract the seal due to a pressure differential across a seal wall. As the pressure differential increases, the seal increasingly expands due to the convolution and promotes the formation of a sealing arrangement between adjacent parts.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A seal for sealing a flow control valve, comprising:
an inlet configured to mate with a flow control device;
an outlet configured to mate with a housing; and
a convolution formed in a seal wall and interposed between the inlet and outlet, the convolution expanding the seal wall when a differential pressure across the convolution is increased.

2. The seal of claim 1, wherein the convolution contracts when the differential pressure across the convolution is decreased.

3. The seal of claim 1, wherein the inlet is at least one of parabolic and saddle-shaped.

4. The seal of claim 1, wherein the inlet has a radially outwardly projecting inlet flange forming an inlet surface.

5. The seal of claim 1, wherein the convolution projects radially outwardly away from a channel extending between the inlet and the outlet.

6. The seal of claim 1, wherein the convolution is configured to move radially inwardly when the differential pressure across the convolution is increased.

7. The seal of claim 1, wherein the inlet, the outlet, and the convolution are integrally formed with each other in a seal body.

8. The seal of claim 7, wherein the seal body is formed from an elastomeric material.

9. The seal of claim 1, wherein the seal further includes a channel extending between the inlet and the outlet.

10. A seal for preventing leaks in a downstream portion of a flow control valve, comprising:
a contoured inlet configured to sealingly mate with a flow control device;
an outlet configured to sealingly mate with a housing; and
a convolution formed in a seal wall and interposed between the inlet and outlet, the convolution at least one of expanding and contracting in response to a differential pressure across at least one of the seal wall and the convolution to bias the inlet toward the flow control device and to bias the outlet toward the housing.

11. The seal of claim 10, wherein the convolution expands when the differential pressure increases and contracts when the differential pressure decreases.

12. The seal of claim 10, wherein the contoured inlet is at least one of parabolic and saddle-shaped.

13. The seal of claim 10, wherein the convolution projects radially outwardly away from a channel when the pressure differential decreases and lays flat and parallel to the channel when the pressure differential increases.

14. The seal of claim 10, wherein the inlet, the outlet, and the convolution are integrally formed with each other into a seal body constructed from an elastomeric material.

15. A flow control valve for selectively routing a fluid, comprising:
a housing defining an internal cavity, the housing including an inlet and an outlet in fluid communication with the internal cavity;
a flow control device rotatably positioned within the internal cavity, the flow control device defining a generally radial channel configured to provide selective fluid communication between the inlet and the outlet; and
a seal interposed between the flow control device and the outlet, the seal having upstream and downstream surfaces spaced apart by a channel and a convolution formed in a seal wall, the convolution increasingly biasing the upstream surface toward the flow control device and the downstream surface toward the outlet when a differential pressure across the seal wall is increased.

16. The flow control valve of claim 15, wherein the differential pressure across the seal wall is increased by rotating the flow control device towards a closed position.

17. The flow control valve of claim 15, wherein the differential pressure across the seal wall is increased when the flow control device directs the fluid into the internal cavity.

18. The flow control valve of claim 15, wherein the upstream and downstream surfaces and the convolution are integrally formed with each other from an elastomeric material.

19. The flow control valve of claim 15, wherein the flow control device is a rotatable cylinder having a generally radial channel passing therethrough.

20. The flow control valve of claim 15, wherein the upstream surface has a parabolic contour configured to make with a rounded periphery of the flow control device.
